(19) United States
(12) Patent Application Publication
(10) Pub. No.: US 2008/0301227 A1
(43) Pub. Date: Dec. 4, 2008

(54) HIERARCHICAL DOCUMENT PUBLISHING

(76) Inventor: James D. Clayton, Los Altos Hills, CA (US)

Correspondence Address: STRATEGIC PATENTS P.C.., C/O PORTFOLIOIP, P.O. BOX 52050, MINNEAPOLIS, MN, 55402, US

(21) Appl. No.: 11/539,252

(22) Filed: Oct. 6, 2006

Related U.S. Application Data
(60) Provisional application No. 60/724,830, filed on Oct. 7, 2005.
(60) Provisional application No. 60/724,916, filed on Oct. 7, 2005.

(51) Int. Cl. G06F 15/16

(52) U.S. Cl. 709/204

(57) ABSTRACT

In embodiments of the present invention improved capabilities are described for a hierarchical publication of at least one object. Embodiments of the present invention relate to hierarchy publication for creating an object, wherein the object contains a plurality of object parts. Embodiments of the present invention relate to hierarchy publication by creating an object with a plurality of components and associating each of the plurality of components with information relating to a plurality of intended recipients within a hierarchy. Embodiments of the present invention relate to model linking by providing more than one model, each model containing information related to an object to be published, querying a first model for the object information with a first query requesting a complete solution from the first model, and resolving the first query by the first model creating a second query to the at least one other model, the at least one other model returning an information result of the second query to the first model. Embodiments of the present invention relate to virtual data management by providing more than one model, each model containing information, requesting information from the more than one model, and combining a returned result from each of the more than one models into a virtual data source. Embodiments of the present invention relate to dashboard publishing by creating a dashboard, wherein the dashboard contains at least one object part, associating information pertaining to a plurality of potential recipients within a hierarchy with the plurality of object parts within the dashboard, wherein the hierarchy is associated with publishing guidelines, and publishing the dashboard to the at least one recipient in accordance with the hierarchy publishing guidelines.

### CROSS-REFERENCE TO RELATED APPLICATIONS

This application claims the benefit of commonly-owned U.S. application Ser. Nos. 60/724,830 filed on Oct. 7, 2005 and 60/724,916 filed on Oct. 7, 2005. Each of these applications is incorporated by reference in its entirety.

### BACKGROUND

1. Field:

This invention relates to the field of publishing objects to recipients and more specifically, publishing the object to hierarchical recipients within an organizational hierarchy using hierarchy organizational identifiers.

2. Description of the Related Art:

Various available software solutions allow users to “publish” reports, dashboards, documents, etc. to other users. The standard approach for enabling this is to allow a user to publish to other “user groups”, which may be a collection of users set up in the software (e.g., finance team). This publishing process may involve creating and modifying unique user groups for each group of end user that is to receive the published document. This process may become a time consuming process in industries, such as sales, that may have a high turnover rates. As sales representatives leave and arrive within the company, the user group in a publishing document may need constant maintenance to assure that the end users are added and removed to assure that the reports reach the appropriate users.

Additionally, it is typical to create different publishing documents for different user groups so that the user groups get only the data that is important to them. It may also be typical to create different publishing documents with different data sets for users in the same hierarchical levels so the individual users only get the data that is important to them.

The combination of maintaining the user groups and creating different publication documents for many unique groups may make publishing documents to end users a very time consuming process. The present invention obviates many of these issues.

### SUMMARY

A method and system disclosed herein may include creating an object, wherein the object may contain a plurality of object parts; associating information pertaining to a plurality of potential recipients within a hierarchy with the plurality of object parts, wherein the hierarchy may be associated with publishing guidelines; determining at least one recipient from the plurality of recipients to receive at least one of the plurality of object parts; and publishing the at least one object part to the at least one recipient in accordance with the hierarchy publishing guidelines. The object may be a document, a spreadsheet, a report, a dashboard, an alert, a message, or the like.

The hierarchy may be a set of defined groups of recipients within an organization. The recipients within each defined hierarchy group may have a common organizational identification. The common organization identification may be a region, a district, a territory, a department, a unit, a company, a group within a company, an enterprise, a group within a government, a group within an organization, or the like.

The recipient may be determined by a business rule that determines at least one recipient from the plurality of recipients to receive at least one of the plurality of the object parts. The recipient may be determined by a calculation internal to the object to determine at least one recipient from the plurality of recipients to receive at least one of the plurality of the object parts. The recipient may be determined by a calculation external to the object to determine at least one recipient from the plurality of recipients to receive at least one of the plurality of the object parts. The recipient may be determined by an owner of the object to receive at least one of the plurality of the object parts. The recipient may be determined by an exceeded threshold value that determines at least one recipient from the plurality of recipients to receive at least one of the plurality of the object parts.

A method and system disclosed herein may include creating an object with a plurality of components; associating each of the plurality of components with information relating to a plurality of intended recipients within a hierarchy; and publishing the object in accordance with the associations such that at least one intended recipient from the plurality of intended recipients may be delivered to at least one of the plurality of components. The object may be a document, a spreadsheet, a report, provide information to a dashboard, an alert, a message, or the like.

The hierarchy may be a defined group of individuals within an organization. The recipients within each defined hierarchy group may have a common organizational identification. The common organization identification may be a region, a district, a territory, a department, a unit, a company, a group within a company, an enterprise, a group within a government, is a group within an organization, or the like.

The associated information may be a paragraph, a page, a column, a row, a cell, a data record, a data element, a chart, an image, a symbol, a graphic, or the like.

The recipient may be determined by a business rule that determines at least one recipient from the plurality of recipients to receive at least one of the plurality of the object parts. The recipient may be determined by a calculation internal to the object to determine at least one recipient from the plurality of recipients to receive at least one of the plurality of the object parts. The recipient may be determined by a calculation external to the object to determine at least one recipient from the plurality of recipients to receive at least one of the plurality of the object parts. The recipient may be determined by an owner of the object to receive at least one of the plurality of the object parts. The recipient may be determined by an exceeded threshold value that determines at least one recipient from the plurality of recipients to receive at least one of the plurality of the object parts.

A method and system disclosed herein may include providing more than one model, each model containing information related to an object to be published; querying a first model for the object information with a first query requesting a complete solution from the first model; resolving the first query by the first model creating a second query to the at least one other model, the at least one other model returning an information result of the second query to the first model; and completing the solution of the first query to the object, the first model retuning the complete solution. The model may contain data, metadata, or the like. The model may be an application, a spreadsheet, a workspace, a database, a table, an XML document, a document, or the like.

The second query may be created by the first model. The information requested by the second query may not available in the first model.

Any of the at least one other models may pass a query to any one of the other at least one models. A result of the query may be returned to the requesting model. A result of each query may be returned from all the at least one other models until the first query has all the required information to complete the first query.

A method and system disclosed herein may include providing more than one model, each model containing information; requesting information from the more than one model; and combining a returned result from each of the more than one models into a virtual data source. The model may contain data, metadata, or the like. The model may be an application, a spreadsheet, a workspace, a database, a table, an XML document, a document, or the like. The request may be a query, a rule, a script, a measure, or the like.

There may be more than one request for model information to be combined into the virtual data source. The more than one request may be combined into a single request. The more than one request may be individual requests.

The virtual data source may contain data, metadata, or the like. The virtual data source may be an application, a spreadsheet, a workspace, a database, a table, an XML document, a document, or the like.

The method and system may further include a user interacting with the virtual data source. A result of the interaction may be a report, a document, a spreadsheet, a dashboard, an alert, a message, or the like. A report may be published from the virtual data source. A document may be published from the virtual data source. A spreadsheet may be published from the virtual data source. A dashboard may be published from the virtual data source. An alert may be published from the virtual data source. A message may be published from the virtual data source.

The method and system may further include a first model creating a query to request information from at least one other model. The at least one other model may return information to the first model in response to the first model query. The first model may return information in response to the requested information.

A method and system disclosed herein may include creating a dashboard, wherein the dashboard may contain at least one object part; associating information pertaining to a plurality of potential recipients within a hierarchy with the plurality of object parts within the dashboard, wherein the hierarchy may be associated with publishing guidelines; determining at least one recipient from the plurality of recipients to receive at least one of the plurality of object parts within the dashboard; and publishing the dashboard to the at least one recipient in accordance with the hierarchy publishing guidelines. The dashboard object part may be a document, a spreadsheet, a report, an alert, a message, or the like.

The hierarchy may be a set of defined groups of recipients within an organization. The recipients within each defined hierarchy group may have a common organizational identification. The common organization identification may be a region, a district, a territory, a department, a unit, a company, a group within a company, an enterprise, a group within a government, a group within an organization, or the like.

The recipient may be determined by a business rule that determines at least one recipient from the plurality of recipients to receive at least one of the plurality of the dashboard object parts. The recipient may be determined by a calculation internal to the dashboard to determine at least one recipient from the plurality of recipients to receive at least one of the plurality of the dashboard object parts. The recipient may be determined by a calculation external to the dashboard to determine at least one recipient from the plurality of recipients to receive at least one of the plurality of the dashboard object parts. The recipient may be determined by an owner of the dashboard to receive at least one of the plurality of the dashboard object parts. The recipient may be determined by an exceeded threshold value that determines at least one recipient from the plurality of recipients to receive at least one of the plurality of the dashboard object parts.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 shows an embodiment of a publishing document accessing data and publishing to users.

FIG. 2 shows an embodiment of a data source associating users with an organizational hierarchy.

FIG. 3 shows an embodiment of setting an organizational hierarchy to a publication document.

FIG. 4 shows an embodiment of a query on a first model and the first model accessing a second model.

FIG. 5 shows an embodiment of rules acting on data sources and integrating the information into a virtual data source.

FIG. 6 shows an embodiment of a virtual data source.

FIG. 7 shows an embodiment of rules being applied to a plurality of data sources.

FIG. 8 depicts an embodiment of a dashboard setup and maintenance interface.

### DETAILED DESCRIPTION

An aspect of the present invention relates to electronic object or content creation, management, and publishing. In embodiments, systems and methods described herein are intended to manage the creation of electronic objects, such as documents, where the documents are assembled from various object parts (e.g. sections of a document). The systems and methods may be adapted to permit the assembly of an overall object through several related sections and associate each of the several sections with people or groups within a hierarchy of people. The associations may be intended to help in the dissemination of the object or object parts to the correct people within an organization for example. As a more pointed example, a hierarchical document creation facility may be adapted to allow an organization to create a document through the assembly of various parts. Each of the parts of the document may contain relevant information for a particular group of people. The hierarchical document creation facility may be associated with a hierarchy of individuals, departments, groups, companies or the like within an organization. For example, the hierarchy may define the various departments (e.g. sales, finance, engineering, manufacturing, purchasing, logistics, marketing, public relations) within a corporation. As the document is created, or after it is complete, the document management facility may be used to create associations between the various pieces of the document with various groups or individuals from the hierarchy describing them. The creator or manager of a particular document may determine the associations such that the correct groups get to review the sections of the document that pertain to them or to receive other forms of publications that are tailored to their needs. Using these systems and methods, one can create a master document assembled of various parts so the various parts can be published in a selective way such that the recipients only receive information that is relevant to them. Such systems and methods may also be used to control access to various parts of the master document. For example, a master document may be created to describe a new product offering and the master document may contain marketing information, logistics information, pricing information, cost information, sales information, manufacturing information, manufacturing specifications, marketing specifications and the like. The corporation may elect to allow its sales force access to a limited portion of the master document, such as the marketing and sales related information, but it may not want to allow access to other portions of the master document, such as manufacturing specification or certain financial information. With the systems and methods disclosed herein, the corporation could make the desired associations between the portions of the document and the sales organization (i.e. a sales department within a corporate hierarchy). When the sales groups requests access to the document or when the document is otherwise published, the sales group may only be permitted access to the associated sections.

As indicated herein, an electronic object, such as a document, may be developed and stored in several associated portions with the intention of associating the several associated portions with groups or individuals within a hierarchy to control publication of the several portions. In embodiments, the several portions are tagged with information relating to the hierarchy. For example, a portion may be stored in a format that includes a document tag and the document tag may be used to create an association with other document portions and/or hierarchy members. When a request for publication is made, the tag may be reviewed to make the appropriate associations and publications. As indicated herein, there are several methods and systems that may be used to control the associations related to the object portions.

Systems and methods described herein relate to creating, editing, manipulating, viewing, controlling, accessing, publishing, and otherwise controlling the access to or interaction with electronic objects and object portions. Embodiments of the present invention relate to the management software relating to the object. The management software may include dashboard views and other graphical user interfaces adapted to help an administrator, author, reviewer and the like manage the objects and portions thereof.

Systems and methods described herein also relate to generating and using data models adapted to control, manage or otherwise manipulate information that is presented through publication. The data models may be adapted to provide updated or variable views of published information. For example, graphs may be presented in a publication and the graphs may be generated or manipulated through the use of variable algorithms. As the algorithms or associated variables are changed, the graph may also be changed so the published graph is effectively published. In other embodiments, publication may relate to static images or be related to data from particular sources or times.

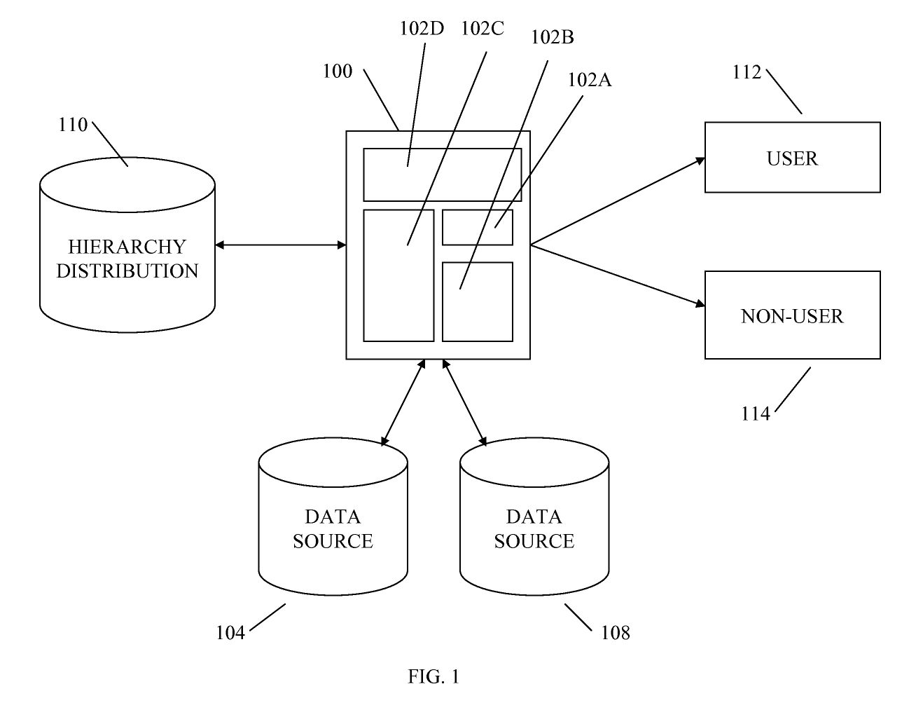

FIG. 1 illustrates a publishing object 100 accessing data sources 104 and 108, accessing organizational hierarchy information 110, and publishing to user 112 and non-user 114. In an embodiment, an object 100 may be published by a publisher; the publisher may be a creator of the object 100, an owner of the object 100, a user responsible for the content of the object 100, or the like. The publisher may publish the object 100 as a spreadsheet, a text document, a presentation, a visual document, an audio document, a HTML document, a dashboard, an alert, a message, a report, or the like to end users within an organization. In an embodiment, the publishing of the object 100 may be the distribution of the object 100 to users, sending a notification to users that the object 100 is available to be viewed, sending an email with the published object 100 attached, or the like. The end users of the object 100 may be any user within a hierarchy of an organization, enterprise, group, or the like. Such users may be referred to as “hierarchical users” and such organizations, enterprises, groups, and the like may be referred to as “hierarchical groups”. Within a hierarchy, things may be located in terms of an absolute position, a relative position, a segment of the hierarchy, and so on. The hierarchical user may have a hierarchical association to at least one part of the organization. For example, the hierarchical user may belong to a hierarchical group called sales and may also be part of a hierarchical group called managers. Publishing the object 100 may encompass distributing the object 100, with associated data, to a selected set of hierarchical users. The selected set of hierarchical users may be selected from a hierarchical user database, determined by information internal to the object 100, determined by data external to the object 100, or the like.

The publishing of the object 100 may not to specific users, but rather to the hierarchical designation to which users are associated. For example, an object 100 may be published to a hierarchical group within the organization such as a sales department. Sales departments may typically experience continual personnel changes (i.e., the users may continually change). By publishing to the sales hierarchy, any user associated with the sales department may receive the published object 100. Publishing to the hierarchy eliminates the need to change the publishing requirements of the object 100 every time there is a user change within a hierarchical group.

In an embodiment, the publisher may want the end user to be able to view only the information that may be pertinent to the end user. FIG. 1 depicts an embodiment of object 100 publishing with associated information that may be distributed to end users based on the end user's hierarchical position in an organization. Further, the publisher may associate information that is applicable to all of the end users and a filter based on the end users hierarchical position may restrict the end user information view to only information that is applicable to that end user. For example, a publisher may publish an object 100 with all of the associated information for one thousand sales representatives in an organization. The publisher may publish the document to an organization hierarchy wherein users are linked to the hierarchy, such as and without limitation by job function (i.e., sales representative, accountant, engineer, marketing representative, and so on). When the hierarchical end user sales representative opens the published document, the document may only include sales representative accessible information. The information within the object 100 may use the hierarchical filter to publish only information for a product line, item type, region, or the like. For example, the object 100 that was published to the one thousand sales representatives may have a hierarchy filter that provides all one thousand sales representatives with different published objects 100 with only their product information available for viewing; the individual sales representatives may not be able to view other products within the published object 100. Using a link between the end user and the organizational hierarchy, the published document may only display a subset of data that is applicable to each individual end user sales representative.

The hierarchical user may be linked to aspects of the object 100 so that when the object 100 is published to the hierarchical user, only information linked to the hierarchical user will be published to the hierarchical user. For example, within a spreadsheet, the hierarchical user may be linked to information within a cell, column, row, worksheet, or the like. When the worksheet is published, each individual hierarchical user may only receive information to which the hierarchical user is linked. In this case, the hierarchical user may be a sales representative responsible for certain products and the hierarchical user may receive the spreadsheet with only the hierarchical user's product information. In an embodiment, the object 100 may be created to allow the hierarchical user to drill down to additional hierarchical information that may be within the hierarchical group. For example, a hierarchical user (in this example, a manager) may receive the published object 100 as part of a manger's hierarchy. The manager may receive information that contains a manager's view of the sales information. The manager may be able to further drill down into the information to view the details of the sales for particular products.

In addition to the hierarchical publishing and hierarchical filtering, the publication of the object 100 may be based on a threshold value being exceeded. The threshold may be a value that is internal to the information within the object 100, a value that is external to the information within the object 100, or the like. For example, the object 100 may be published whenever a value within the object 100 exceeds a certain value (e.g. sales figures for a quarter). When the threshold value is exceeded, the object 100 may be published to only the hierarchical users that have responsibility for the exceeded information. For example, if there are ten departments within an enterprise, and one department's sales figures had declined beyond a specified amount, only the one department would receive a published object 100 and the published object may only have information relating to the one department.

While preferred embodiments of the present invention are disclosed in connection with a hierarchical organizational structure, it will be appreciated that these are only exemplary illustrations, and that structures may be segmented in other ways. For example and without limitation, structures may be segmented by party, affiliation, identity, name, address, status, value, date, or any and all other discerning factors.

A publishing object 100 may be a spreadsheet, a text document, an HTML document, a dashboard, an alert, a message, or a report that may have associated data 102 (e.g. sections including 102A-D). The publishing object 100 may be published to a plurality of hierarchical end users, including users 112 and non-users (defined hereinafter) 114 that may then gain access to the data contained in the publishing object 100. The publisher may publish the object to the end users 112 and 114 using a hierarchy distribution 110 data source. It will be appreciated that there may be more than one hierarchy distribution 110 data source. There may be a hierarchy distribution 110 data source for each hierarchy group, a combined hierarchy distribution 110 source, or the like. The hierarchy distribution 110 data source may include a data source that may link an end user to one or more hierarchical organizations, groups, or the like. The hierarchy distribution 110 data source may be at least one of a database, a table, an XML file, a text file, human resource database (e.g. PeopleSoft database), a spreadsheet, or the like. The hierarchy distribution 110 data source may store the end user identification, the end users position within the organization hierarchy, any relationships to organizational responsibility, affiliations, status, availability or other parameter to determine the distribution of a particular section 102 of the document. During the object 100 publication process, the publisher may link the publication object 100 to at least one hierarchy distribution 110, and all or a portion of the end users linked to the hierarchy distribution 110 may receive the publication. By publishing the publication document 100 to an organization hierarchy the publisher may be able to publish the object 100 to entire levels of the organization hierarchy instead of having to build distribution list containing a plurality of individual user identifications.

The publication object 100 associated data 102 may be any data that may be stored in a data source 104 or 108. In this example, two data sources are shown, but it should be understood that any number of data sources may be used to support the object 100. The data sources 104 and 108 may be a database, a table, an XML file, a text file, a spreadsheet, or the like. In an embodiment, the publisher may create a query using rules, to extract data for the object 100 to be published to end users. This is further discussed below. In another embodiment, the object 100 may be linked to the information in the data sources 104 and 108. It should be understood that the data source 104 and 108 information contained within the object 100 may use any standard method of data association between the object 100 and data sources 104 and 108. The publisher may extract data from the data source 104 or 108 that would be applicable to all the end users that are to receive the published object 110. For example, one data source 104 may contain company names in a sales representatives territory and another data source 108 may contain sales information for the companies listed in the first data source 104. This information from the first data source 104 and the second data source 108 may be combined into the publication object 100.

When the object 100 is published to the end users 112 and 114, the publication object 100 may extract the appropriate data from the data sources 104 and 108 and use the hierarchy distribution 110 to publish the object 100 to the appropriate end users 112 and 114. In an embodiment, the end users 112 and 114 may be classified as users 112 and non-users 114. The users 112 may be end users that have access to a system where the publication object 100 and data sources 104 and 108 are available. In this case, the user 112 may be able to log into the system to access the published object 100. The non-user 114 may be classified as a user that may not have access to the system where the publication object 100 and data sources 104 and 108 reside. In an embodiment, the non-user may be a remotely located user without system access, may be a third party that requires the published object 100 information but is not permitted access to the system, or the like. The non-user may receive the published object 100 as an email attachment, an instant message, or the like. In an embodiment, the user 112 may be considered a non-user 114 at times when the user 112 is not able to access the system. For example, when a sales person is visiting customers, the sales person may not be able to access the system to review the published object 100. In this case the user 112 may receive the published object 100 as an email attachment similar to the non-user 114 receiving the published object 100. The hierarchy distribution 110 data source may store user and non-user hierarchy distribution information.

When the user 112 and/or the non-user 114 receive the published publication document 100, all of the data, or links to the data, for all of the end users may be contained in the published object 100. The published object 100 may also contain the hierarchy distribution 110 information, or links to the hierarchy information, that may contain the user identification and related end user 112 and 114 information to associate the user with the data in the published document. For example, the hierarchy distribution 110 information may contain the sales representative identification and all of the companies for which the sales representative is responsible. The publication object 100 may use the hierarchy distribution 110 information as a hierarchical filter for the user 112 such that when the user 112 opens the published object 100 the user may only have access to a subset of the data that matches the users 112 identification and related information. For example, the sales representative may only have access to data that matches the sales representatives identification and companies for which the sales representative is responsible. In an embodiment, if there are hierarchical levels below the end user 112 and non-user 114, the end user 112 and end-user 114 may be able to drill down within the data to view data at the lower level. Using this publishing method, the publishing user may be able to publish all the data for all of the end users in one object 100 to an organizational hierarchy and restrict the end users data view. This permits the publishing user to create one publishing object 100 for a plurality of end users and still have the end user view only data that is applicable to the individual end user.

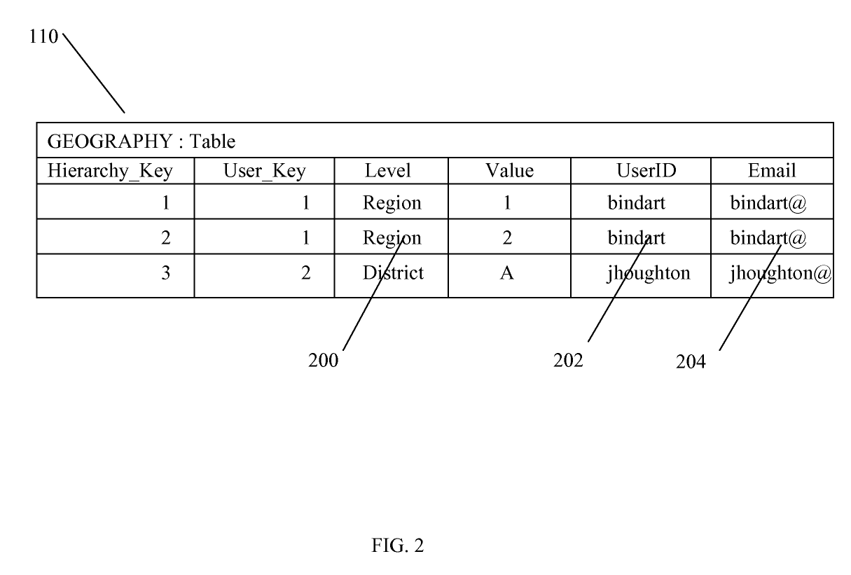

Referring to FIG. 2, an embodiment of the hierarchy distribution 110 information is shown. The hierarchy distribution 110 information may a database, a table, an XML file, a text file, a spreadsheet or other information repository. The hierarchy distribution 110 information may contain end user information for the relationship of the end user to an organization hierarchy. In an embodiment, the hierarchy distribution 110 information may contain end user information such as the hierarchy level 200, user ID 202, Email address 204, and any additional information that may identify the end users responsibilities within the hierarchy (e.g. product line, company sales, or materials). The hierarchy distribution 110 information may be included in the publishing document 100 and may be used to identify the hierarchical levels to publish the publishing object 100. For example, when publishing the object 100, the publisher may publish to the “Region”; this may have the object 100 publish only to users in the hierarchy distribution 110 with a level of “Region” to receive the published object 100. The hierarchy distribution 110 information may also be used for hierarchical filtering the end user data view for the published object 100. For example, UserID jhoughten may only be able to view data associated with a “District” level where UserID bindart will be able to view the “Region” level data. If the “District” is a lower hierarchy level than the “Region”, then UserID bindart may be able to view both the “Region” and “District” levels. In an embodiment, a higher level hierarchy may be able to drill down into data at a lower hierarchy level.

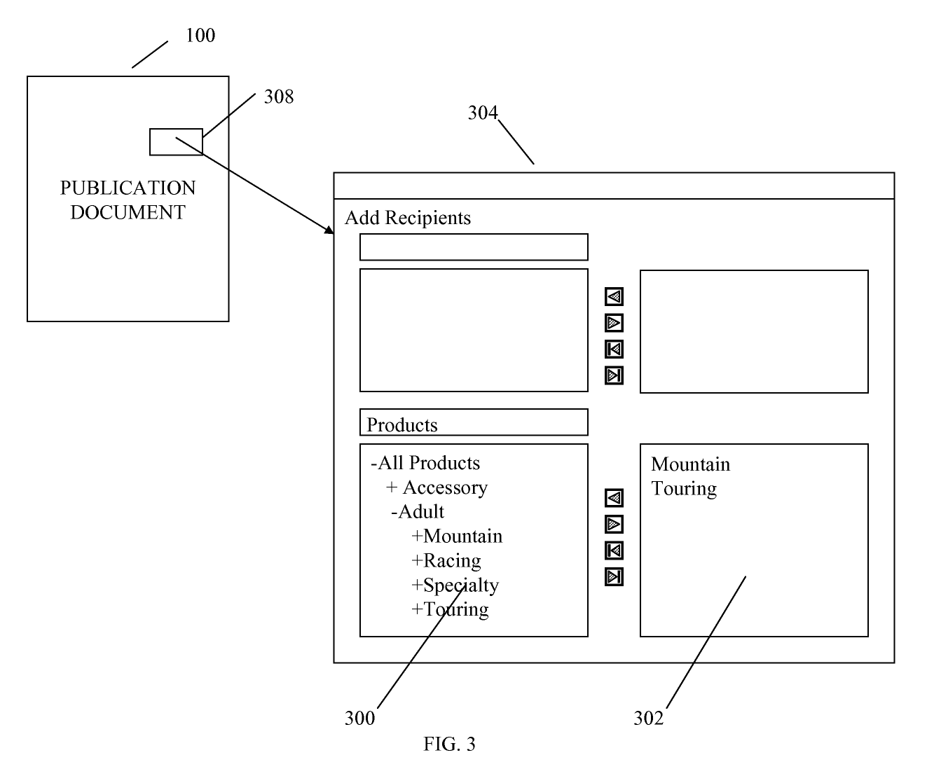

Referring to FIG. 3, an embodiment of linking hierarchy level information to the publishing object 100 is shown. The publication user may link 308 the hierarch level to the publication object 100 by opening a window to show the available hierarchy levels for distribution. An embodiment of a hierarchy level selection window 304 is shown. There may be a hierarchy selection object 300 that may display all of the available hierarchy levels for a selected group. The publisher may select at least one hierarchy level for publishing distribution by selecting the hierarchy level and moving it to the distribution text box 302. Hierarchy levels in the distribution text box 302 may be used to distribute and filter data as discussed above in FIG. 1.

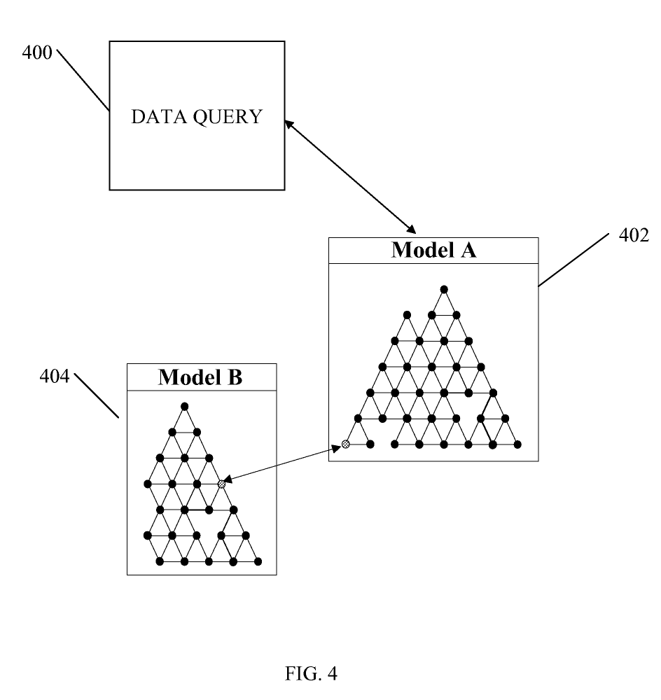

Referring to FIG. 4, an embodiment of a query 400 acting on a first model 402 and the first model 402 querying information from a second model 404 is shown. In embodiments, data may be distributed in a plurality of data sources and in a plurality of data fact files within a data source as shown in the two models 402 and 404 shown in FIG. 4. It will be appreciated that there may be any number of models within an enterprise storing all the data facts that are required. The plurality of data sources may have been developed as part of a data source strategy, as part of different applications developed at different times, or the like.

The query 400 may be a result of a publishing user extracting data from a data source 104 and/or 108 for a publishing object 100. Model A 402 and Model B 404 may reside in any data source, and may have a relationship or common field and or may be a relational database. Other models may reside on additional data sources in the same or different physical locations. The query 400 may be requesting data from Model A 402, but Model A 402 may not contain all of the requested data. For example, Model A 402 may have company information where Model B 404 may have the product information for the companies stored within Model A 402. Model A 402 may then create a second query for Model B 404 requesting the additional information that may be required to complete the first query 400 to Model A 402. Model B 404 may provide a data return to the Model A 402 query and the Model A 402 may combine the Model B 404 data return with its own data to provide a complete data return to the publishing user query 400. In an embodiment, the ability of one model to query a second model to complete the query to the first model may be considered horizontal scaling or model-to-model data resolving. An example may be Model A 402 is a promotion planning application, which in part, relies upon an elasticity curve, which is modeled in Model B 404. If an analyst changes the way the elasticity curve is calculated, Model B 404 automatically uses this improved curve in its analysis. By breaking the models up, applications can be more easily tuned to the user group while maintaining the analytic connection between the two. This means a pricing manager may be able to look at a pricing application, all of which is relevant to him, while the promotion manager may be working with a promotion application that doesn't include pricing functionality in it, though it is connected to changes in the pricing application.

Additionally, it should be understood that any of the models within a storage warehouse might be able to generate a query to any other model within the storage warehouse. As an example, a first query may be made to a first model and the first model may create a query to one or more additional models for information that is not contained in the first model. Additionally, the one or more models may similarly create queries of other models for additional information. In an embodiment, as the models gather the requested information for the queries from other models, the information may be passed to the requesting model which then may complete gathering its information and pass the information to its requesting model. The gathering and passing information in response to the queries may continue until the first model has all the information required to complete the information requested by the first query.

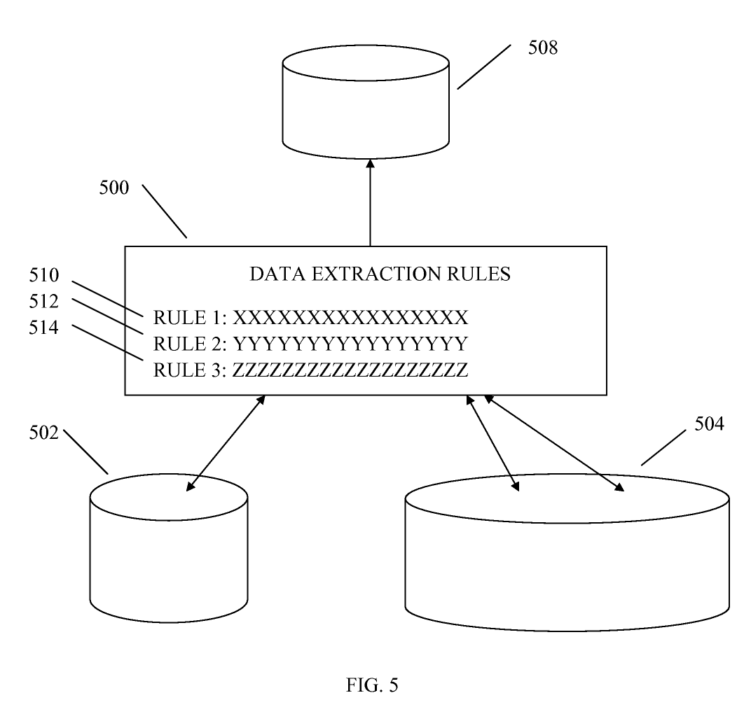

The model-to-model data resolving discussed in FIG. 4 may be used in the creation of a virtual data source for use in object 100 publishing. Referring to FIG. 5, an embodiment of rules 500 acting on data sources 502 and 504 and integrating the information into a virtual data source 508 is shown. When a publisher query 400 extracts data, the data may come from a plurality of data sources 502 and 504 and may be combined into a virtual data source 508 within a computer device memory. The object's 100 publication may be enabled by using the virtual data source 508 to provide information that is required for the object's 100 publication. The virtual source 508 may be stored in volatile memory in a computer environment and may not be written to a physical data location. It will be appreciated that there may be a plurality of data sources and that the two data sources 502 and 504 are depicted for the purpose of illustration and not limitation.

A query may be executed by a data extraction rules 500 set to extract data from a plurality of data sources that may be in common or remote location. For example, the data extraction rules set may consist of rule one 510, rule two 512, and rule three 514. Rule one 510 may retrieve data from the first data source 502 and rule two 512 and rule three 514 may retrieve data from the second data source 504. The virtual data source 508 may combine the three independent data results into an analytical server for processing and combining of the data received from the data sources 502 and 504. The virtual data source 508 may then be used for the publication object 100 using the virtual data source 508 the same as if the data was stored in a physical data source.

As discussed in FIG. 4, the data extraction rules 500 that act on the data sources 502 and 504 may cause the data sources 502 and 504 to create queries to other data sources to retrieve information not contained within the data source 502 and 504. Once the data sources 502 and 504 have received all the requested information from the queried models, the data sources 502 and 504 may pass the complete information to the virtual data source 508.

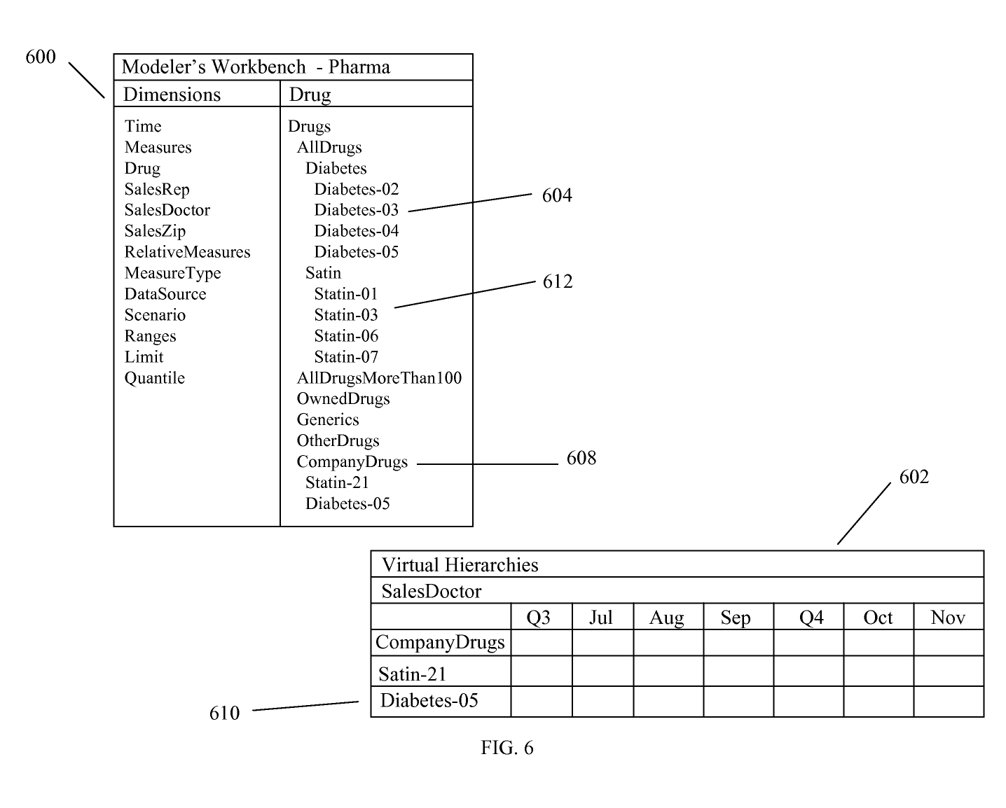

Referring to FIG. 6, an embodiment of a virtual data source is shown. Using the rules as described in FIG. 5, “virtual hierarchies” may be created; the virtual hierarchies may be hierarchies that may contain organize data that may not exist in an underlying fact data model. The virtual hierarchies may have members that are pulled from a plurality of different data sources including data retrieved by first model from a second model. This capability may allow users to view the data in a way that makes sense to them, as opposed to the way the data is described in the underlying fact data model. The virtual hierarchies may allow this to occur across data sources, which may allow the presentation of a single view of data, even though it resides in multiple sources.

In the data hierarchy window 600, the drug hierarchy AllDrugs/Diabetes 604 and AllDrugs/Statin 612 may exist in physical data; each drug hierarchy may be coming from a different fact table and may be integrated under the parent AllDrugs. In an embodiment, the hierarchy “CompanyDrugs” 608 may not exist in physical data, and each individual member may be coming from a plurality of different fact tables. In an embodiment, the information supporting the “CompanyDrugs” 608 hierarchy may have been created using a rules query as described in FIG. 5. The virtual hierarchy data may then become a selectable hierarchy for publishing in the object 100. In the report view 602, the virtual data CompanyDrugs 610 hierarchy may roll up Statin-21 and Diabetes-05 values from the virtual data source 508. The values of the report may be used as if the data source was in a physical data source. With this virtual hierarchy, a user may do analysis on all drugs owned by the company, even though the fact tables for each drug may be in a different data source and there's no hierarchy in data that combines these members.

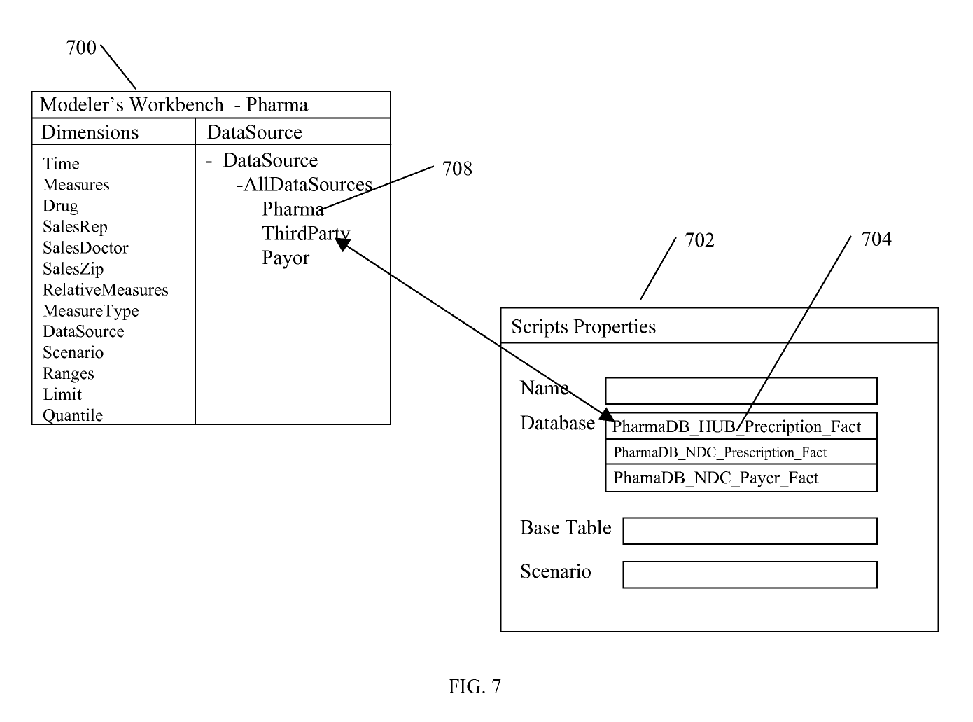

Referring to FIG. 7, an embodiment of rules being applied to a plurality of data sources is shown. By combining the previously discussed model-to-model data resolving and using rules to create virtual data sources without moving data, the virtual data sources may be dimensionalized. In an embodiment, the dimensionalized virtual data source may provide for the same information structure for different aspects of the virtual data source, therefore the different aspects may be analyzed in the same manner using different data sources. A virtual data source may be dimensionalized by the virtual data source having a structure similar to the data sources from which information was extracted using the rules. For example, if the virtual data source 508 was created from more than one data source, the virtual data source 508 may maintain the virtual information in the structure of the originating data sources. As shown in a data source window 700, the virtual data source “Pharma” may be dimensionalized into a number of different dimensions. The dimension “DataSource” may be further dimensionalized to contain the data sources of “Phama”, “ThirdParty”, and “Payor”.

The data rules window 702 may contain a plurality of data rules 704 for the creation of a plurality of dimensionalized data sources 708 as shown in the data source window 700. The same rules 704 may access the different models in physical data sources to extract different sets of virtual data. For example, by running one of the three rules 704, the three different virtual data sources may be created (e.g. Pharma, Thirdparty, and Payor). In this manner, the same analysis may be done using different data sources in different physical locations.

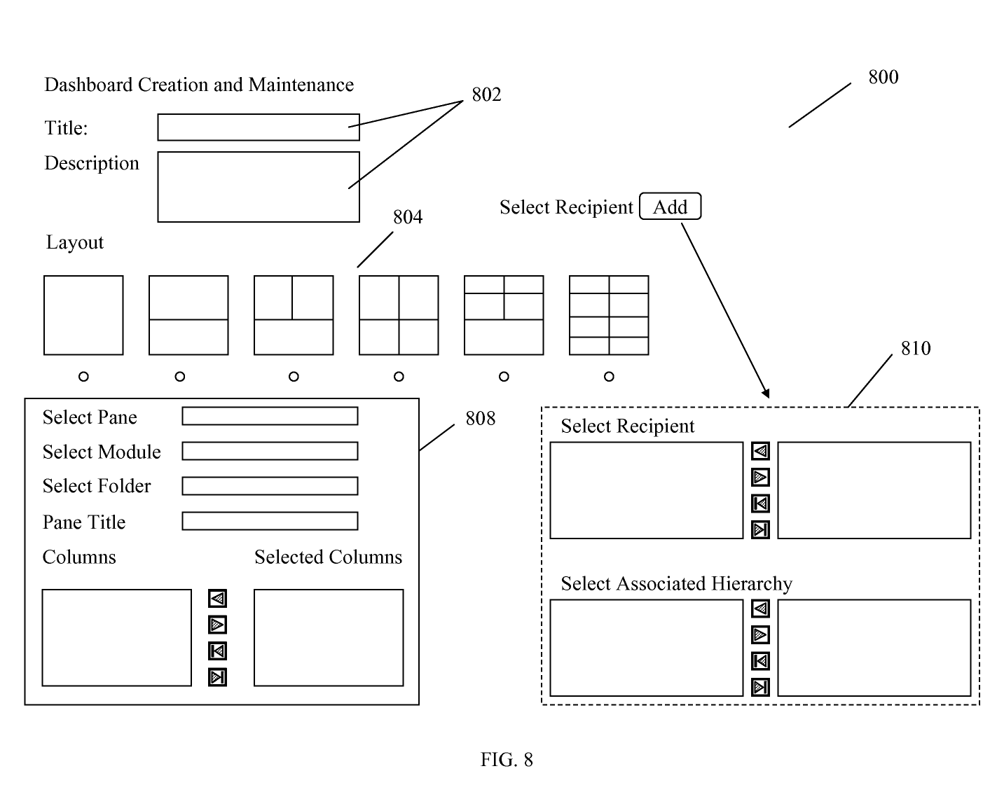

In an embodiment, as previously described, objects 100 may be published to dashboards that may include documents, spreadsheets, alerts, messages, and the like. Dashboards may incorporate a number of different objects 100 into one interface to provide alerts, action notices, next steps, summaries of business conditions, and the like to users. FIG. 8 depicts an embodiment of a dashboard setup and maintenance interface 800 where the publisher may determine the dashboard type, information to display on the dashboard, and the users to receive the dashboard.

In an embodiment, the publisher may be able to provide an overall title and description 802 information to the dashboard; this information may be provided as a top-level title and overview of the information within the dashboard. As depicted in the layout section 804, there may be a number of different layout choices that the publisher may choose to display all the desired objects 100 parts. For example, the dashboard may have as few as one display area to a plurality of display areas, all of which may contain a publication object 100 parts to be published to recipients and/or hierarchical groups. In an embodiment, consistent with the above descriptions of publishing the object 100, a recipient may only be able to view the object 100 part that is associated with the recipient. For example, in a two-part dashboard, a first object 100 part may have manager object 100 for a sales department and a second object 100 part may have an individual sales person object 100. The manager may be able to view both of the dashboard object 100 parts while the individual sales person may only be able to view the sales persons object 100 part. In another example, the dashboard may be divided into sales department display areas and when the dashboard is published only the object 100 parts requiring attention may be displayed on the dashboard (e.g. a sales department missing a sales projection).

In an embodiment, there may be a dashboard pane information selection 808 in the dashboard interface 800. The publisher may be able to associate many different types of objects 100 to the dashboard to provide the information required to a set of users. The dashboard may contain a document, a spreadsheet, an alert, a message, or the like. In a multi-pane dashboard, the publisher may be able to select which pane to display each object 100 within the dashboard. Within each object 100 of the dashboard, the publisher may also be able to determine the sub-set of information to display within the object 100 such as a particular set of cells in a spreadsheet, a certain set of data records from a data source, a certain part of a document, or the like. In an embodiment, the publisher may also be able to provide rules for the display of the objects 100 within the dashboard that may determine when certain objects are displayed with the dashboard is published.

In an embodiment, the publisher may be able to add recipients to the dashboard. The recipients may be selected by individual, by group, by hierarchical group, level within a hierarchical group, or the like. In an embodiment, the publisher may be able to select any combination of individual, group, hierarchical group, or the like to receive the dashboard. As previously discussed, the dashboard may be published to the indicated recipients, but only certain recipients may be able to view the objects 100 or object parts within the dashboard depending of the display rules associated with each object 100 of the dashboard. The objects 100 within the dashboard may have restricted viewing by hierarchy level, by alert level, or the like.

In an embodiment, similar to dashboards described herein, any type of object 100 may be published to recipients. The publisher may be able to select the object 100 to be published, select recipients, and publish the object. In an embodiment, any object 100 that may be displayed within a dashboard may be published individually to a recipient. In an embodiment, the individual objects 100 may have management interfaces similar to the dashboard interface 800 for the selection and publishing of the object 100.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method of hierarchy publication, comprising:
creating an object, wherein the object contains a plurality of object parts;
associating information pertaining to a plurality of potential recipients within a hierarchy with the plurality of object parts, wherein the hierarchy is associated with publishing guidelines;
determining at least one recipient from the plurality of recipients to receive at least one of the plurality of object parts; and
publishing the at least one object part to the at least one recipient in accordance with the hierarchy publishing guidelines.

2. The method of claim 1, wherein the object is a document.

3-4. (canceled)

5. The method of claim 1, wherein the object provides information to a dashboard.

6. The method of claim 1, wherein the object is an alert.

7. (canceled)

8. The method of claim 1, wherein the hierarchy is a set of defined groups of recipients within an organization.

9-19. (canceled)

20. The method of claim 1, wherein the recipient is determined by a business rule that determines at least one recipient from the plurality of recipients to receive at least one of the plurality of the object parts.

21. The method of claim 1, wherein the recipient is determined by a calculation internal to the object to determine at least one recipient from the plurality of recipients to receive at least one of the plurality of the object parts.

22. The method of claim 1, wherein the recipient is determined by a calculation external to the object to determine at least one recipient from the plurality of recipients to receive at least one of the plurality of the object parts.

23. The method of claim 1, wherein the recipient is determined by an owner of the object to receive at least one of the plurality of the object parts.

24. The method of claim 1, wherein the recipient is determined by an exceeded threshold value that determines at least one recipient from the plurality of recipients to receive at least one of the plurality of the object parts.

25. A method of hierarchy publication, comprising:
creating an object with a plurality of components;
associating each of the plurality of components with information relating to a plurality of intended recipients within a hierarchy; and
publishing the object in accordance with the associations such that at least one intended recipient from the plurality of intended recipients is delivered at least one of the plurality of components.

26. The method of claim 25, wherein the object is a document.

27-28. (canceled)

29. The method of claim 25, wherein the object provides information to a dashboard.

30. The method of claim 25, wherein the object is an alert.

31. (canceled)

32. The method of claim 25, wherein the hierarchy is a defined group of individuals within an organization.

33-54. (canceled)

55. The method of claim 25, wherein the recipient is determined by a business rule that determines at least one recipient from the plurality of recipients to receive at least one of the plurality of the object parts.

56. The method of claim 25, wherein the recipient is determined by a calculation internal to the object to determine at least one recipient from the plurality of recipients to receive at least one of the plurality of the object parts.

57. The method of claim 25, wherein the recipient is determined by a calculation external to the object to determine at least one recipient from the plurality of recipients to receive at least one of the plurality of the object parts.

58. The method of claim 25, wherein the recipient is determined by an owner of the object to receive at least one of the plurality of the object parts.

59. The method of claim 25, wherein the recipient is determined by an exceeded threshold value that determines at least one recipient from the plurality of recipients to receive at least one of the plurality of the object parts.

60-278. (canceled)
